(19) United States
(12) Patent Application Publication
(10) Pub. No.: US 2026/0184423 A1
(43) Pub. Date: Jul. 2, 2026

(54) Vertical Take-Off And Landing Aircraft

(71) Applicant: Joby Aero, Inc., Santa Cruz, CA (US)

(72) Inventors: Gregor Veble MIKIC, Santa Cruz, CA (US); JoeBen BEVIRT, Santa Cruz, CA (US); Edward STILSON, Santa Cruz, CA (US); Zach REEDER, Santa Cruz, CA (US); David Benjamin TRONER, Santa Cruz, CA (US); Alec Morgan CLARKE, Austin, TX (US); Alborz SAKHAEI, Santa Cruz, CA (US)

(21) Appl. No.: 19/042,017

(22) Filed: Jan. 31, 2025

Related U.S. Application Data
(60) Provisional application No. 63/627,693, filed on Jan. 31, 2024.

(51) Int. Cl. B64C 29/00; B64C 1/14; B64C 7/02; B64D 27/40

(52) U.S. Cl. CPC B64C 29/0033; B64C 1/1407; B64C 7/02; B64D 27/402

(57) ABSTRACT

An aerial vehicle configured a main fuselage and an upper nacelle coupled to the top of the main fuselage. The aerial vehicle may have an air intake in an otherwise higher drag location. In some aspects, the aerial vehicle is a vertical take-off and landing aircraft. The aircraft may intake the air to provide air to a hydrogen fuel cell system or a turbogenerator within the aircraft, which may reside withing the upper nacelle. The aircraft may have electric motor driven rotor assemblies which provide thrust for both vertical take-off and landing and forward flight operations. The electric motor driven rotor assemblies may be powered by electric power from the fuel cell system. The aircraft may have pivoting wings with rotor assemblies which may provide thrust in both a forward flight configuration and a vertical take-off and landing (hover) configuration.

### CROSS-REFERENCE TO RELATED APPLICATIONS

This application claim priority to U.S. Provisional Patent Application No. 63/627,693 to Mikic et al, filed Jan. 31, 2024, which is hereby incorporated by reference in its entirety.

### FIELD OF THE INVENTION

This invention relates to aerial vehicles, including a vertical take-off and landing aircraft with pivoting wings.

### SUMMARY OF THE INVENTION

An aerial vehicle configured a main fuselage and an upper nacelle coupled to the top of the main fuselage. The aerial vehicle may have an air intake in an otherwise higher drag location. In some aspects, the aerial vehicle is a vertical take-off and landing aircraft. The aircraft may intake the air to provide air to a hydrogen fuel cell system or a turbogenerator within the aircraft, which may reside withing the upper nacelle. The aircraft may have electric motor driven rotor assemblies which provide thrust for both vertical take-off and landing and forward flight operations. The electric motor driven rotor assemblies may be powered by electric power from the fuel cell system. The aircraft may have pivoting wings with rotor assemblies which may provide thrust in both a forward flight configuration and a vertical take-off and landing (hover) configuration.

### BRIEF DESCRIPTION OF THE DRAWINGS

FIGS. 1A-E are of a first embodiment of a VTOL aircraft in a forward flight configuration according to some embodiments of the present invention.

FIGS. 2A-D are of a first embodiment of a VTOL aircraft in a hover configuration according to some embodiments of the present invention.

FIGS. 3A-B are of a first embodiment of a VTOL aircraft in a hover configuration.

FIGS. 4A-E are of a second embodiment of a VTOL aircraft in a forward flight configuration according to some embodiments of the present invention.

FIGS. 5A-D are of a second embodiment of a VTOL aircraft in a hover configuration according to some embodiments of the present invention.

FIGS. 6A-E are of a third embodiment of a VTOL aircraft in a forward flight configuration according to some embodiments of the present invention.

FIGS. 7A-D are of a third embodiment of a VTOL aircraft in a hover configuration according to some embodiments of the present invention.

FIGS. 8A-C are illustrations of wing cant according to some embodiments of the present invention.

### DETAILED DESCRIPTION

Aerial vehicles according to embodiments of the present invention function to provide an aerial vehicle operable between a hover mode and a forward mode. The hover mode can include vertical takeoff, vertical landing, and/or substantially stationary hovering of the aircraft; however, the hover mode can additionally or alternatively include any suitable operating mode wherein vertically-directed thrust is generated by one or more of the plurality of propulsion assemblies. The forward mode can include forward flight, horizontal takeoff, and/or horizontal landing of the aircraft (e.g., conventional take-off and landing/CTOL); however, the forward mode can additionally or alternatively include any suitable operating mode wherein horizontally-directed thrust is generated by one or more of the plurality of propulsion assemblies. The aircraft can also function to provide an aerial vehicle that is stable in hover mode (e.g., maximally stable, stable within a defined stability window or envelope of flight conditions, stable up to a stability threshold magnitude of various control inputs to the aircraft, etc.) and efficient (e.g., aerodynamically efficient, power efficient, thermodynamically efficient, etc.) in forward mode. The aircraft can also function to provide airborne transportation to passengers and/or cargo. However, the aircraft can additionally or alternatively have any other suitable function.

The propeller of the propulsion assembly functions to convert rotational kinetic energy supplied by the electric motor to aerodynamic forces (e.g., for propelling the aircraft in the hover mode, the forward mode, etc.). The propeller can include a number of propeller blades (e.g., blades, airfoils, etc.), a head (e.g., a hub and associated linkages), and any other suitable components. The propeller may be a variable-pitch propeller (e.g., wherein the pitch of each propeller blade is variable coordination such as via collective control, wherein the pitch of each propeller blade is independently variable such as via cyclic control, etc.), but can additionally or alternatively be a fixed-pitch propeller. In some variations, the aircraft can include both variable-pitch and fixed-pitch propeller associated with different propulsion assemblies of the plurality of propulsion assemblies. In additional or alternative variations, the propeller can be articulated into a negative angle of attack condition, which can function to produce reverse thrust without changing the direction of rotation of the propeller. The propeller can define any suitable disc area (e.g., propeller disc, disc, etc.), and each blade can define any suitable cross section and/or twist angle as a function of blade span.

In a specific example, each propeller of the plurality of propulsion assemblies includes a set of propeller blades attached to the hub by a variable pitch linkage that rotates each propeller blade about a long axis of the propeller blade and constrains propeller blade motion normal to the disc plane (e.g., the propeller blade does not substantially articulate forward or backward from the disc plane). The propellers can provide lift associated with an angle of attack relative to the incoming airstream during forward flight, relative to the longitudinal axis of the aircraft, and/or relative to the wing of the aircraft as defined by the chord line of the wing cross-section, as discussed further below.

Aircraft according to embodiments of the present invention can include a power distribution system that couples an electric power source to each electrically-powered component (e.g., including each electric motor). The power distribution system can include an electrical power transmission bus that distributes power from a plurality of electric power sources to components of the aircraft requiring electrical power. Each propulsion assembly is preferably connected to at least one associated electric power source that powers the electric motor assembly of the propulsion assembly. However, the electric power sources can additionally or alternatively be interconnected to one another and/or to one or more propulsion assemblies such that any propulsion assembly (or other powered component) can draw electrical power from any suitable subset of electric power sources of the aircraft 100, with any suitable relative power draw between electric power sources.

In some embodiments of the present invention, the aerial vehicle has an airflow nacelle located at the structural coupling points of the left side wing and the right side wing to the aircraft fuselage. In utilizing this location, the air inlet of the airflow nacelle integrates air inflow into an otherwise unused, and high drag, portion of the aerial vehicle. The airflow nacelle may include space within to accommodate most or all of the power provision components for the aerial vehicle, which may include batteries, a turbogenerator, fuel cell systems, or other power components, including fuel. The airflow nacelle may also include space within to accommodate the flight electronics of the aerial vehicle.

With this configuration, more room is available within the fuselage for passengers, cargo, or other equipment. Forward of the coupling location of the left wing and the right wing to the main body fuselage is a section of the upper surface of the fuselage. As will be seen in other embodiments below, this area of drag creation may be utilized as the location of the airflow nacelle in some aspects.

The airflow nacelle, having an air inlet at a forward end of the airflow nacelle, has an airflow exit at a rearward end of the airflow nacelle. In some aspects, the inletted air may be routed to a thermodynamic fuel cell system, as discussed further below. In some aspects, the inletted air is routed through heat exchangers which form part of the fuel cell system. In some aspects, the inletted air is used in a combustion based generator which supplies electrical power to the electric motors of the propulsion assemblies. In some aspects, a turbo-electric hybrid system is used, with most or all of the power generation components residing within the airflow nacelle. A turbogenerator within the airflow nacelle is adapted to provide electrical power to the electric motors of the rotor assemblies. With a turbogenerator, air may be inletted at a further rearward location along the airflow nacelle. In some aspects, batteries also reside within the airflow nacelle. The batteries may be used to provide auxiliary power as needed in addition to the power provided by the turbogenerator. In some aspects, the batteries are sized to provide full power for takeoff and landing hovers, for transition, and for initial climbing. The turbogenerator is adapted to provide charging for the batteries during flight.

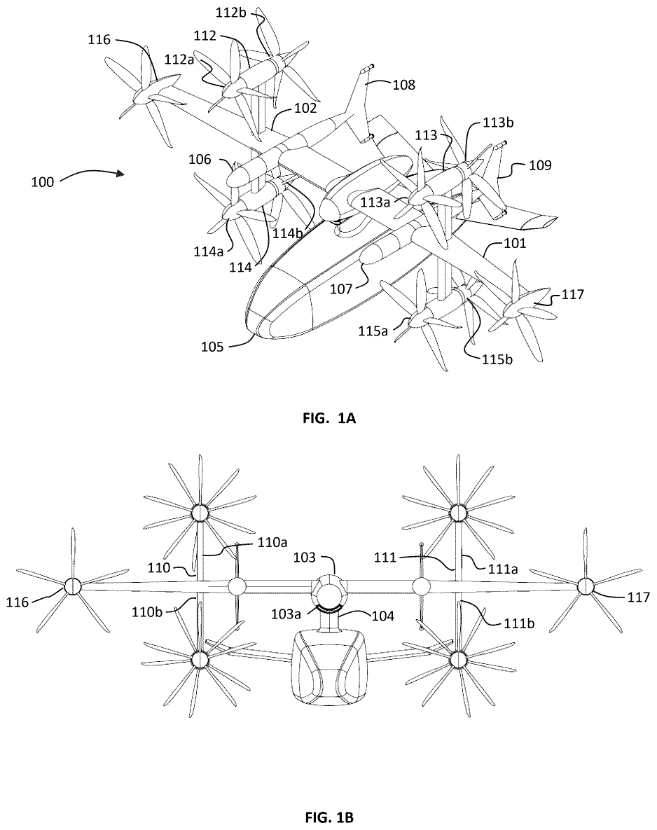

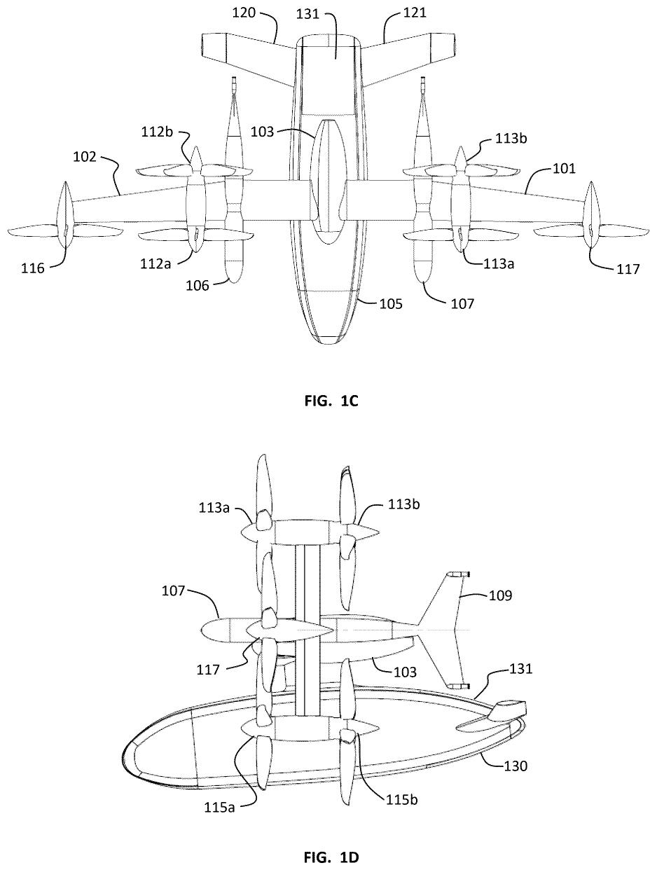

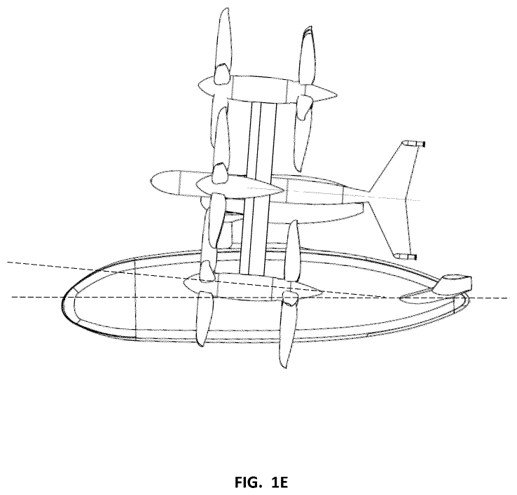

In a first illustrative embodiment of the present invention, as seen in a forward flight configuration in FIGS. 1A-1D, an aerial vehicle 100 has a main body fuselage 105 coupled to a left wing 101 and a right wing 102. In this illustrative embodiment, the fuselage 105 resides below the wings 101, 102 so that the center of mass of the fuselage is below the wings. The left wing 101 and the right wing 102 are coupled to an airflow nacelle 103. The airflow nacelle 103 is coupled to a coupler section 104, which is in turn coupled to the fuselage 105. An airflow inlet 103a intakes air into the airflow nacelle 103, inletting air from what would otherwise be an area of high drag during forward flight. In some aspects, the coupler section 104 allows for removable coupling of the fuselage 105 from the airflow nacelle 103. The aerial vehicle may be configured to be fully functional for flight operations with the fuselage 105 decoupled and not part of the aerial vehicle.

In this illustrative ten rotor embodiment, the left wing 101 has a vertical pylon 111 with an upper vertical pylon 111a coupled to an upper motor nacelle 113. A forward upper left wing propulsion assembly 113a is coupled to a forward end of the upper motor nacelle 113, and a rearward upper left wing propulsion 113b assembly is coupled to a rearward end of the upper motor nacelle 113. The lower vertical pylon 111b is coupled to a lower motor nacelle 115. A forward lower left wing propulsion assembly 115a is coupled to a forward end of the lower motor nacelle 115, and a rearward lower left wing propulsion assembly 115b is coupled to a rearward end of the lower motor nacelle 115. The right wing 102 has a vertical pylon 110 with an upper vertical pylon 110a coupled to an upper motor nacelle 112. A forward upper right wing propulsion assembly 112a is coupled to a forward end of the upper motor nacelle 110, and a rearward upper right wing propulsion 112b assembly is coupled to a rearward end of the upper motor nacelle 112. The lower vertical pylon 110b is coupled to a lower motor nacelle 114. A forward lower right wing propulsion assembly 114a is coupled to a forward end of the lower motor nacelle 114, and a rearward lower right wing propulsion assembly 114b is coupled to a rearward end of the lower motor nacelle 114.

In an illustrative embodiment, each of the propulsion assemblies has an electric motor coupled to a propeller, with a blade pitch control mechanism configured to adjust the blade pitch of each of the propeller blades simultaneously. A left wingtip rotor 117 is coupled to the outboard tip of the left wing 101, and a right wingtip rotor 116 is coupled to the outboard tip of the right wing 102. Inboard of the right side vertical pylon 110 is a left wing nacelle 107, and inboard of the left side vertical pylon 111 is a right wing nacelle 106. In some aspects, the wing nacelles 106, 107 may be configured to contain batteries, fuel, electronics, or other flight support items. At the rearward end of the left side wing nacelle 107 is a landing strut 109, and at the rearward end of the right side wing nacelle 106 is a landing strut 108. In some aspects, the rearward projection from the side wing nacelle may provide a fixed aerodynamic surface to assist in aircraft trim in forward flight. The fixed aerodynamic surface may be seen on both sides of the aircraft.

The angle of attack of the upper right wing propulsion assemblies 112a, 112b and the lower right wing propulsion assemblies 114a, 114b may be offset from the wing of the aircraft, as defined by the chord of the cross-section of the wing, by a first angle. The angle of attack of the upper left wing propulsion assemblies 113a, 113b and the lower left wing propulsion assemblies 115a, 115b may be offset from the wing of the aircraft, as defined by the chord of the cross-section of the wing, by the same first angle. The angle of attack of the right wingtip rotor 116 and the left wingtip rotor 117 may be offset from the wing of the aircraft by a second angle. Using a different offset angle on the wingtip rotors relative to the offset angle of the inboard rotors may allow for better yaw control during hover operations of the aircraft. In some aspects, one of either the wingtip rotors or the inboard rotors may be not be offset, with the other offset at a non-zero angle.

In an illustrative embodiment, the angle of attack of the upper right wing propulsion assemblies 112a, 112b and the lower right wing propulsion assemblies 114a, 114b and the upper left wing propulsion assemblies 113a, 113b and the lower left wing propulsion assemblies 115a, 115b may be offset from the wing of the aircraft by zero degrees (not offset), as defined by the chord of the cross-section of the wing, while the angle of attack of the right wingtip rotor 116 and the left wingtip rotor 117 may be offset from the wing of the aircraft by +9 degrees. In another illustrative example, the angle of attack of the upper right wing propulsion assemblies 112a, 112b and the lower right wing propulsion assemblies 114a, 114b and the upper left wing propulsion assemblies 113a, 113b and the lower left wing propulsion assemblies 115a, 115b may be offset from the wing of the aircraft by a first angle in the range of −3 to +3 degrees, as defined by the chord of the cross-section of the wing, while the angle of attack of the right wingtip rotor 116 and the left wingtip rotor 117 may be offset from the wing of the aircraft by a second angle in the range of 6-12 degrees. In some aspects, all of the rotors (inboard and wingtip) may be offset by an angle in the range of −5 to +15 degrees, with the inboard rotors offset from the wingtip rotors as discussed above. In some aspects, all of the rotors (inboard and wingtip) may be offset by an angle in the range of −15 to +30 degrees, with the inboard rotors offset from the wingtip rotors as discussed above. It should be understood that a rotor offset to the wing chord by a negative angle does not necessarily lead to a situation where the rotor is canted downward relative to the freestream, as the wing itself may be flown in an angle of attack range which is larger than the negative angle of attack of the rotor relative to the wing chord.

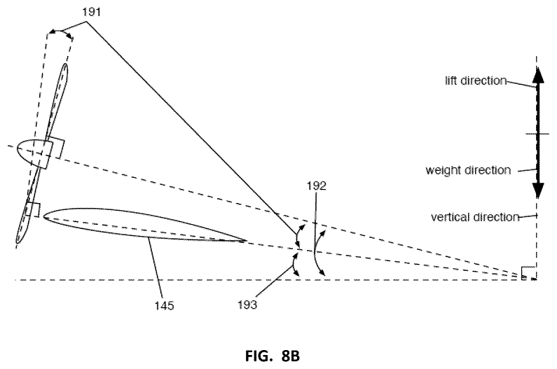

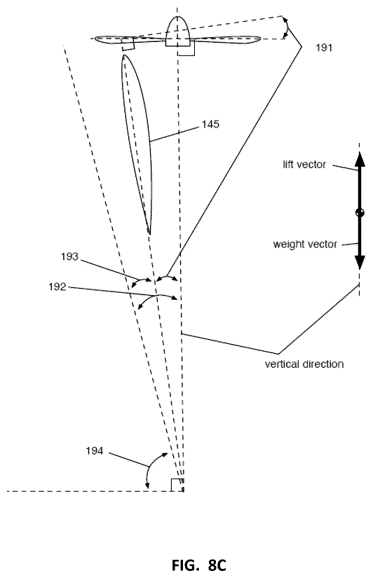

The rotors can provide lift associated with an angle of attack of the rotor disc relative to: the incoming airstream during forward flight, longitudinal axis of the aircraft, wing of the aircraft (e.g., the chord line 146 of the wing cross section 145), and/or other reference axis or plane. The angle of attack of the rotor disc relative to the wing (e.g., chord line 146 of the wing) can be negative, positive, or zero, and may be within the ranges bounded by the aforementioned values. An example of the angle of attack of the rotor disc relative to the wing 191 is illustrated in FIG. 8A. An example of the angle of attack of the rotor disc 192 is illustrated in FIG. 8B. The overall angle of attack of the rotor disc 192 is seen to be the sum of the wing angle of attack 193 and the angle of attack of the rotor disc relative to the wing 191The rotor disc angle of attack (relative to the wing or otherwise) can be defined (e.g., measured) relative to the rotor axis of rotation, motor axis of rotation, a vector orthogonal to the rotor disc plane, and/or any other suitable reference. The angle of attack of the rotor preferably transforms based on the transformation of the tilt mechanism and/or pitch of the aircraft. Preferably, the rotor disc planes are substantially parallel to the lateral/longitudinal plane (pitch/roll plane) in the hover configuration, and angled relative to the vertical/lateral plane (yaw/pitch plane) in the forward configuration (and/or hover configuration). Accordingly, the tilt mechanism preferably transforms the wing by 90 degrees less the rotor disc angle of attack while transitioning between the forward and hover configurations (an example is illustrated in FIG. 8C), however the tilt mechanism can transform the wing by 90 degrees plus the rotor disc angle of attack while transitioning between the forward and hover configurations, exactly 90 degrees between the forward and hover configurations, and/or any other suitable transformation angle. In a specific variant, the transformation between forward and hover can include tilting past vertical (e.g., creating a rearward thrust vector) in order to arrest forward motion of the vehicle. In some aspects, as when the inboard rotors are canted to a different angle relative to the wing chord than the outboard rotors, the tilt mechanism can transform the wing by an amount controlled to provide the desired lift, attitude, and yaw rate, if any. In some aspects, the aircraft will not have any further controllable control surfaces, such as ailerons, rudders, or rear controllable horizontal stabilizers.

FIGS. 1D and 1E illustrate different horizontal flight configurations for the aerial vehicle 100. FIG. 1D illustrates the disc planes of the rotors in a substantially perpendicular orientation relative to the horizontal flight line of the aerial vehicle. FIG. 1E illustrates the disc planes of the rotors pitch upwards relative to the horizontal flight line of the aerial vehicle.

Along the rearward sides of the main body fuselage 105 are a left side stabilizer 121 and a right side stabilizer 120. An upper rear hatch 131 and a lower rear hatch 130 reside at the rear of the fuselage 105 in between the left side stabilizer 121 and a right side stabilizer 120. In this configuration, the hatches 130, 131 may open without interfering with the stabilizers, allowing for an upper hatch 131. In contrast to earlier designs, the VTOL aspect of the aircraft 100 allows for a fuselage body design that need not slope up at the rear underside, which has been necessary for transport aircraft which engage in forward take-off in order for the lower rear of the aircraft to clear the ground as the aircraft would pitch up during take-off. In addition, the placement of the left side stabilizer 121 and a right side stabilizer 120 outside of the hatch area, also without a rear vertical stabilizer, allows for both an upper and lower hatch, a fuller rear lower cargo area, and may significantly enhance the efficiency of use for packing the fuselage. In some aspects, the aircraft will not have any further controllable control surfaces, such as ailerons, rudders, or rear controllable horizontal stabilizers.

In some aspects, the aerial vehicle may include a right side storage nacelle 106 and a left side storage nacelle 107. In some aspects, the aerial vehicle 100 does not have storage nacelles along the wings. A right rear strut 108 may be coupled to the rear of the right side storage nacelle 106. A left rear strut 107 may be coupled to the rear of the left side storage nacelle 106. The right rear strut 108 and the left rear strut 107 may function as landing struts for the aircraft when landing in a hover configuration. The right rear strut 108 and the left rear strut 107 may also function as stabilizers in some aspects. In some aspects, as when there are no storage nacelles along the wings, there may be landing struts coupled up to the airflow nacelle 103 which extend along the sides of the fuselage 105 configured to support the aerial vehicle while on the ground. In some aspects, the main fuselage 105 may have landing struts configured to support the aerial vehicle while on the ground.

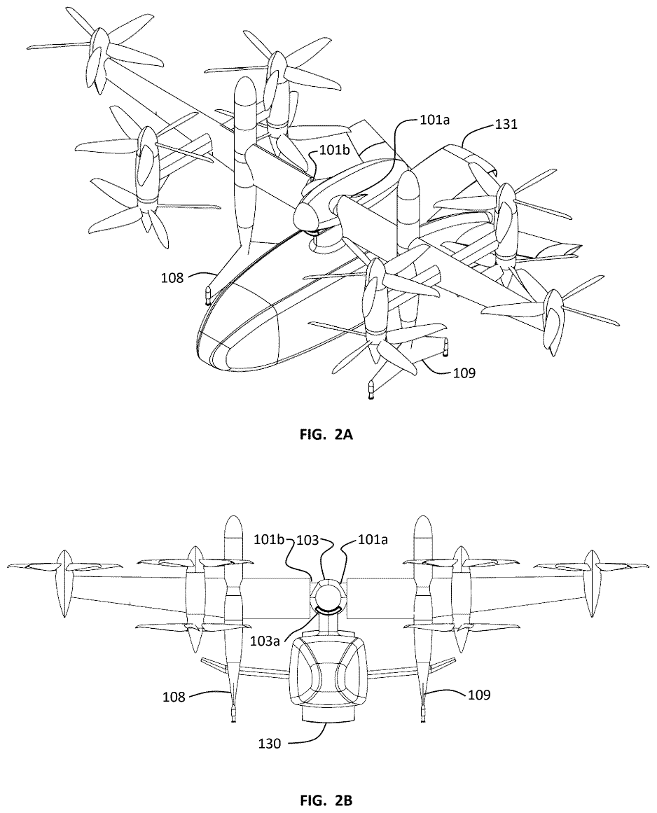

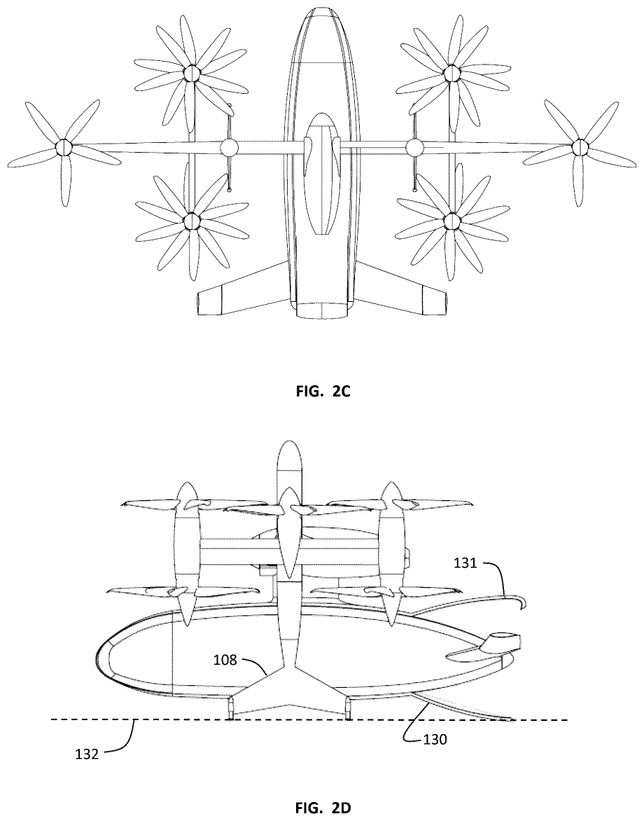

FIGS. 2A-2D illustrate the first embodiment 100 in a hover configuration, with the wings 101, 102 having pivoted from a horizontal forward facing forward flight configuration to a vertical facing vertical take-off and landing hover configuration. A left side pivot 101a facilitates the pivoting of the left wing relative to the airflow nacelle 103 and the fuselage 105, and a right side pivot 101b facilitates the pivoting of the right wing relative to the airflow nacelle 103 and the fuselage 105. FIG. 2D illustrates the aircraft 100 on the ground 132, with the landing struts 108, 109 on the ground and the upper hatch 131 open, and the lower hatch 130 open and residing on the ground. In some aspects, as when there are no storage nacelles along the wings, there may be landing struts coupled up to the airflow nacelle 103 which extend along the sides of the fuselage 105 configured to support the aerial vehicle while on the ground. In some aspects, the main fuselage 105 may have landing struts configured to support the aerial vehicle while on the ground.

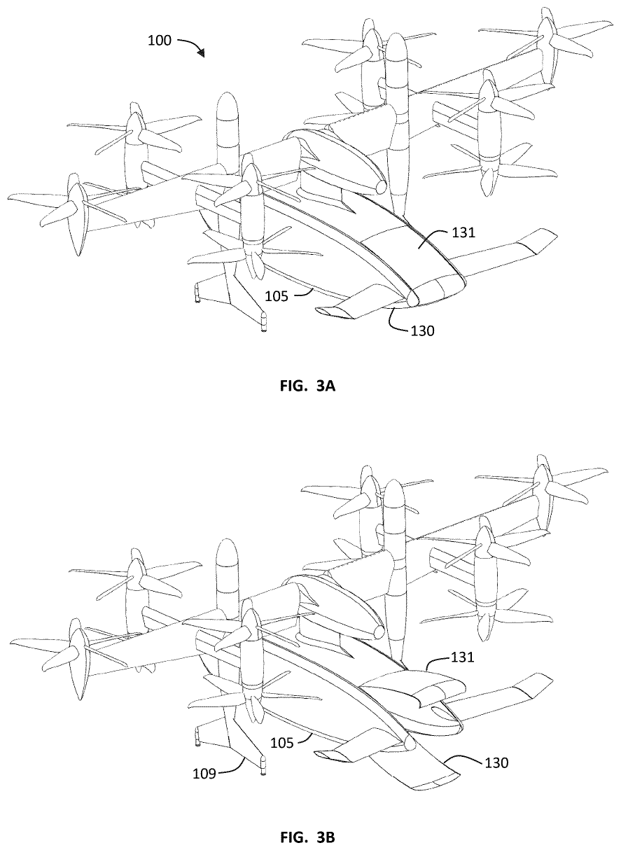

FIGS. 3A and 3B illustrate the aircraft 100 in a hover configuration first with the hatches 130,131 closed in FIG. 3A, and then with the hatches 130, 131 open in FIG. 3B.

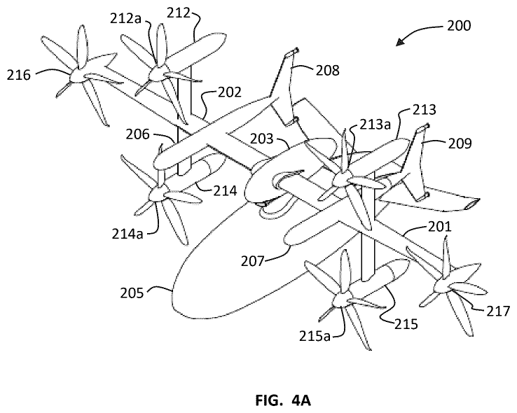

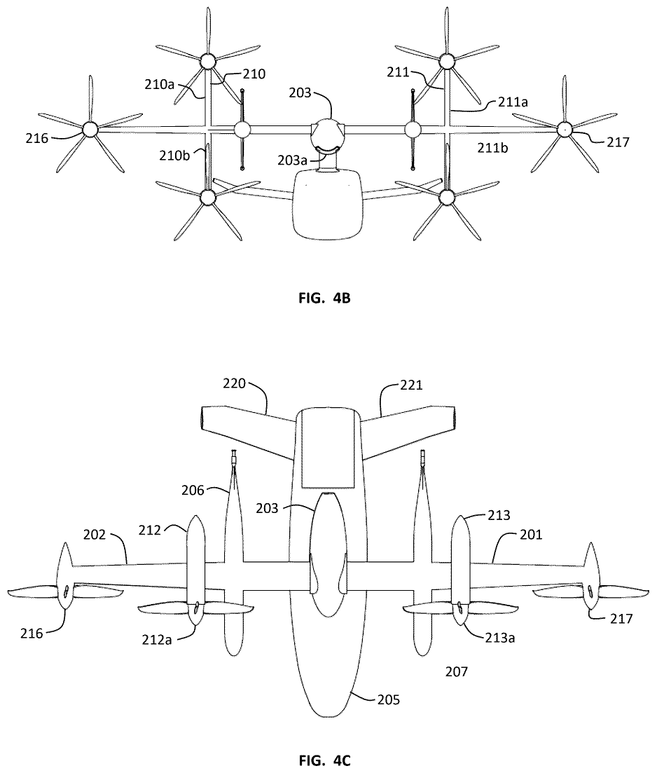

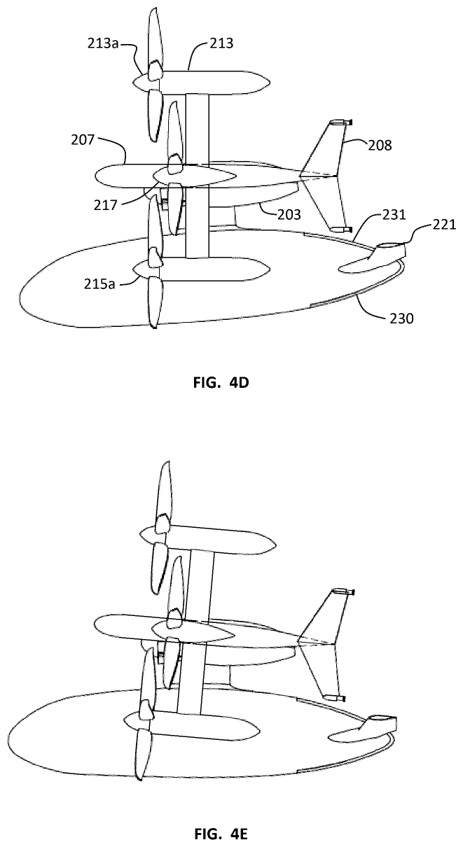

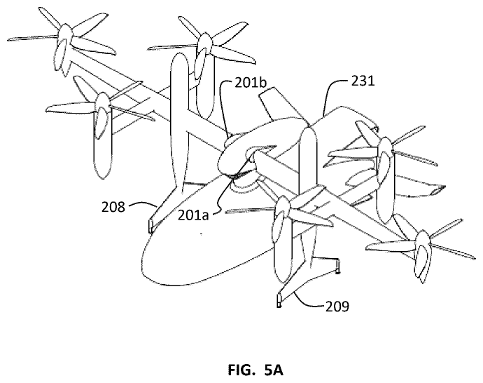

In a second illustrative embodiment of the present invention, as seen in a forward flight configuration in FIGS. 4A-4D, an aerial vehicle 200 has a main body fuselage 205 coupled to a left wing 201 and a right wing 202. In this illustrative embodiment, the fuselage 205 resides below the wings 201, 202 so that the center of mass of the fuselage is below the wings. The left wing 201 and the right wing 202 are coupled to an airflow nacelle 203. The airflow nacelle 203 is coupled to a coupler section 204, which is in turn coupled to the fuselage 205. An airflow inlet 203a intakes air into the airflow nacelle 203, inletting air from what would otherwise be an area of high drag during forward flight. In some aspects, the coupler section 204 allows for removable coupling of the fuselage 205 from the airflow nacelle 203. The aerial vehicle may be configured to be fully functional for flight operations with the fuselage 205 decoupled and not part of the aerial vehicle. In some aspects, the aircraft will not have any further controllable control surfaces, such as ailerons, rudders, or rear controllable horizontal stabilizers.

In this illustrative six rotor embodiment, the left wing 201 has a vertical pylon 211 with an upper vertical pylon 211a coupled to an upper motor nacelle 213. A forward upper left wing propulsion assembly 213a is coupled to a forward end of the upper motor nacelle 213. The lower vertical pylon 211b is coupled to a lower motor nacelle 215. A forward lower left wing propulsion assembly 215a is coupled to a forward end of the lower motor nacelle 215. The right wing 202 has a vertical pylon 210 with an upper vertical pylon 210a coupled to an upper motor nacelle 212. A forward upper right wing propulsion assembly 212a is coupled to a forward end of the upper motor nacelle 210.

The lower vertical pylon 210b is coupled to a lower motor nacelle 214. A forward lower right wing propulsion assembly 214a is coupled to a forward end of the lower motor nacelle 214.

In an illustrative embodiment, the angle of attack of the upper right wing propulsion assembly 212 and the lower right wing propulsion assembly 114a and the upper left wing propulsion assembly 113 and the lower left wing propulsion assembly 115 may be offset from the wing of the aircraft by zero degrees (not offset), as defined by the chord of the cross-section of the wing, while the angle of attack of the right wingtip rotor 216 and the left wingtip rotor 217 may be offset from the wing of the aircraft by +9 degrees. In another illustrative example, the angle of attack of the upper right wing propulsion assembly 212a and the lower right wing propulsion assembly 214a and the upper left wing propulsion assemblies 213 and the lower left wing propulsion assembly 215 may be offset from the wing of the aircraft by a first angle in the range of −3 to +3 degrees, as defined by the chord of the cross-section of the wing, while the angle of attack of the right wingtip rotor 216 and the left wingtip rotor 217 may be offset from the wing of the aircraft by a second angle in the range of 6-12 degrees. In some aspects, all of the rotors (inboard and wingtip) may be offset by an angle in the range of −5 to +15 degrees, with the inboard rotors offset from the wingtip rotors as discussed above. In some aspects, all of the rotors (inboard and wingtip) may be offset by an angle in the range of −15 to +30 degrees, with the inboard rotors offset from the wingtip rotors as discussed above.

In an illustrative embodiment, each of the propulsion assemblies has an electric motor coupled to a propeller, with a blade pitch control mechanism configured to adjust the blade pitch of each of the propeller blades simultaneously. A left wingtip rotor 217 is coupled to the outboard tip of the left wing 201, and a right wingtip rotor 216 is coupled to the outboard tip of the right wing 202. Inboard of the right side vertical pylon 210 is a left wing nacelle 207, and inboard of the left side vertical pylon 211 is a right wing nacelle 206. In some aspects, the wing nacelles 206, 207 may be configured to contain batteries, fuel, electronics, or other flight support items. At the rearward end of the left side wing nacelle 207 is a landing strut 209, and at the rearward end of the right side wing nacelle 206 is a landing strut 208. In some aspects, the aerial vehicle 200 does not have wing nacelles, and the batteries, fuel, and other flight support items reside within the airflow nacelle 203.

Along the rearward sides of the main body fuselage 205 are a left side stabilizer 221 and a right side stabilizer 220. An upper rear hatch 231 and a lower rear hatch 230 reside at the rear of the fuselage 205 in between the left side stabilizer 221 and a right side stabilizer 220. In this configuration, the hatches 230, 231 may open without interfering with the stabilizers, allowing for an upper hatch 231. In contrast to earlier designs, the VTOL aspect of the aircraft 200 allows for a fuselage body design that need not slope up at the rear underside, which has been necessary for transport aircraft which engage in forward take-off in order for the lower rear of the aircraft to clear the ground as the aircraft would pitch up during take-off. In addition, the placement of the left side stabilizer 221 and a right side stabilizer 220 outside of the hatch area, also without a rear vertical stabilizer, allows for both an upper and lower hatch, a fuller rear lower cargo area, and may significantly enhance the efficiency of use for packing the fuselage.

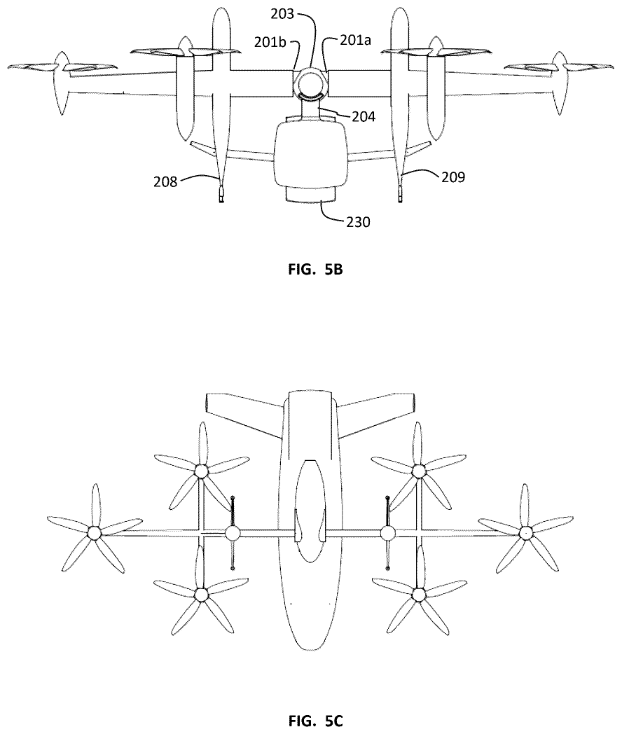

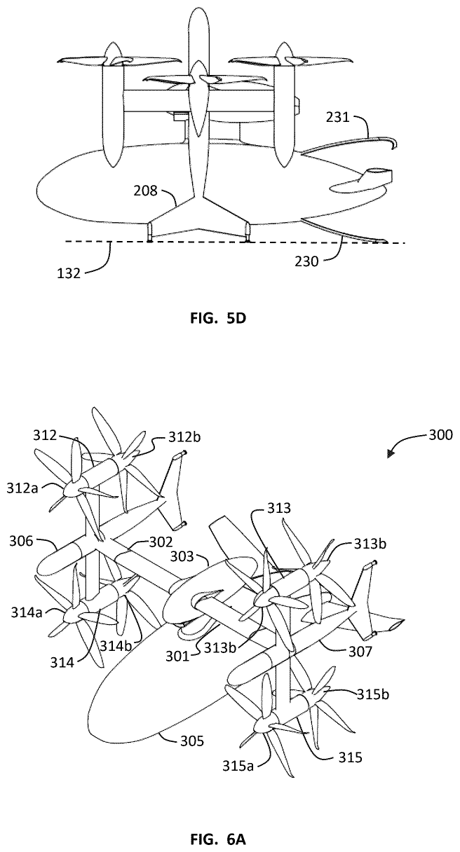

FIGS. 5A-5D illustrate the second embodiment 200 in a hover configuration, with the wings 201, 202 having pivoted from a horizontal forward facing forward flight configuration to a vertical facing vertical take-off and landing hover configuration. A left side pivot 201a facilitates the pivoting of the left wing relative to the airflow nacelle 203 and the fuselage 205, and a right side pivot 201b facilitates the pivoting of the right wing relative to the airflow nacelle 203 and the fuselage 205. FIG. 5D illustrates the aircraft 200 on the ground 132, with the landing struts 208, 209 on the ground and the upper hatch 231 open, and the lower hatch 230 open and residing on the ground. In some aspects, as when there are no storage nacelles along the wings, there may be landing struts coupled up to the airflow nacelle 203 which extend along the sides of the fuselage 205 configured to support the aerial vehicle while on the ground. In some aspects, the main fuselage 205 may have landing struts configured to support the aerial vehicle while on the ground.

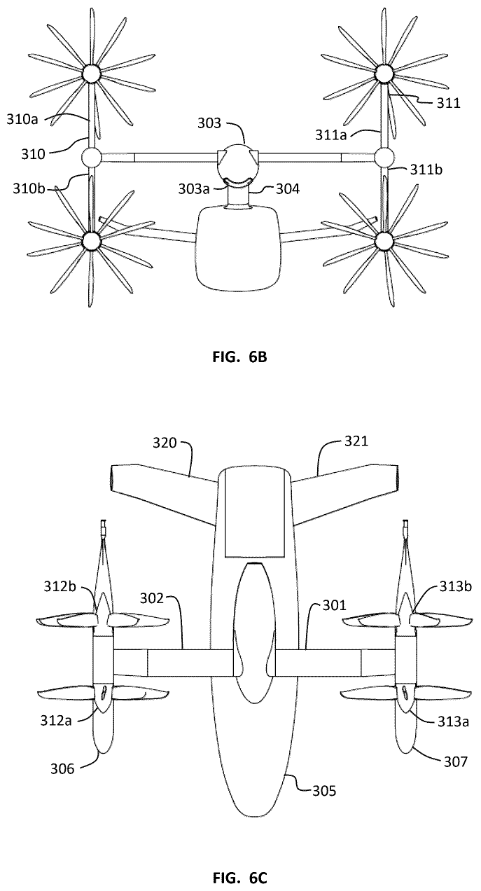

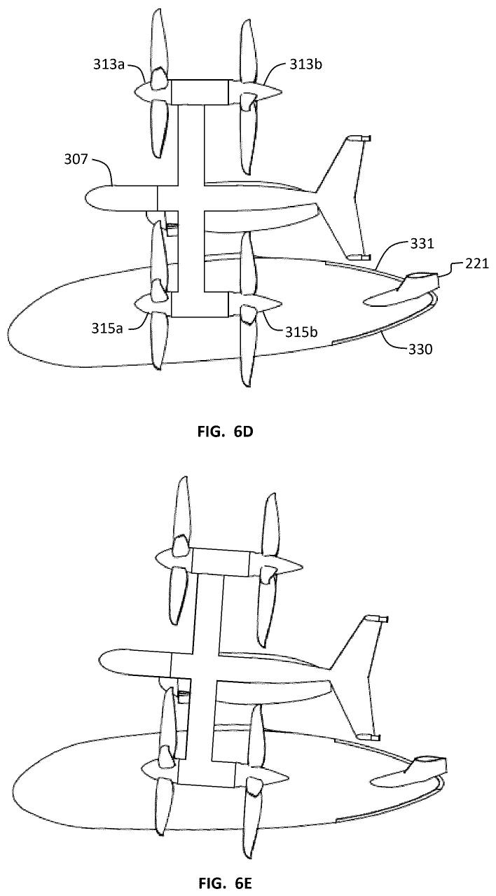

In a third illustrative embodiment of the present invention, as seen in a forward flight configuration in FIGS. 6A-6D, an aerial vehicle 300 has a main body fuselage 305 coupled to a left wing 301 and a right wing 302. In this illustrative embodiment, the fuselage 305 resides below the wings 301, 302 so that the center of mass of the fuselage is below the wings. The left wing 301 and the right wing 302 are coupled to an airflow nacelle 303. The airflow nacelle 303 is coupled to a coupler section 304, which is in turn coupled to the fuselage 305. An airflow inlet 303a intakes air into the airflow nacelle 303, inletting air from what would otherwise be an area of high drag during forward flight.

In this illustrative eight rotor embodiment, the left wing 301 has a vertical pylon 311 with an upper vertical pylon 311a coupled to an upper motor nacelle 313. A forward upper left wing propulsion assembly 313a is coupled to a forward end of the upper motor nacelle 313, and a rearward upper left wing propulsion 313b assembly is coupled to a rearward end of the upper motor nacelle 313. The lower vertical pylon 311b is coupled to a lower motor nacelle 315. A forward lower left wing propulsion assembly 315a is coupled to a forward end of the lower motor nacelle 315, and a rearward lower left wing propulsion assembly 315b is coupled to a rearward end of the lower motor nacelle 315. The right wing 302 has a vertical pylon 310 with an upper vertical pylon 310a coupled to an upper motor nacelle 312. A forward upper right wing propulsion assembly 312a is coupled to a forward end of the upper motor nacelle 310, and a rearward upper right wing propulsion 312b assembly is coupled to a rearward end of the upper motor nacelle 312. The lower vertical pylon 310b is coupled to a lower motor nacelle 314. A forward lower right wing propulsion assembly 314a is coupled to a forward end of the lower motor nacelle 314, and a rearward lower right wing propulsion assembly 314b is coupled to a rearward end of the lower motor nacelle 314.

In an illustrative embodiment, each of the propulsion assemblies has an electric motor coupled to a propeller, with a blade pitch control mechanism configured to adjust the blade pitch of each of the propeller blades simultaneously. At the junction of the right side vertical pylon 310 with the left wing 301 is a left wing nacelle 307, and at the junction of the left side vertical pylon 311 with the right wing 302 is a right wing nacelle 306. In some aspects, the wing nacelles 106, 107 may be configured to contain batteries, fuel, electronics, or other flight support items. At the rearward end of the left side wing nacelle 307 is a landing strut 309, and at the rearward end of the right side wing nacelle 306 is a landing strut 308.

Along the rearward sides of the main body fuselage 305 are a left side stabilizer 321 and a right side stabilizer 320. An upper rear hatch 331 and a lower rear hatch 330 reside at the rear of the fuselage 305 in between the left side stabilizer 321 and a right side stabilizer 320. In this configuration, the hatches 330, 331 may open without interfering with the stabilizers, allowing for an upper hatch 331. In contrast to earlier designs, the VTOL aspect of the aircraft 300 allows for a fuselage body design that need not slope up at the rear underside, which has been necessary for transport aircraft which engage in forward take-off in order for the lower rear of the aircraft to clear the ground as the aircraft would pitch up during take-off. In addition, the placement of the left side stabilizer 321 and a right side stabilizer 320 outside of the hatch area, also without a rear vertical stabilizer, allows for both an upper and lower hatch, a fuller rear lower cargo area, and may significantly enhance the efficiency of use for packing the fuselage.

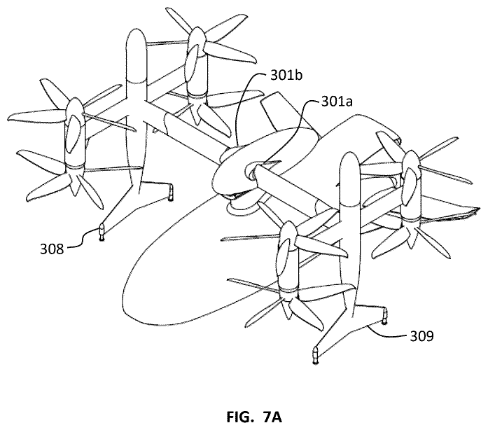

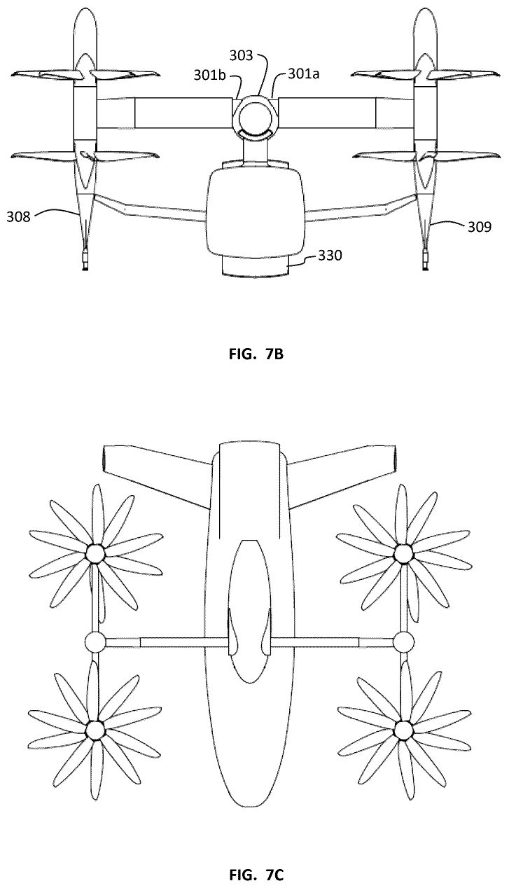

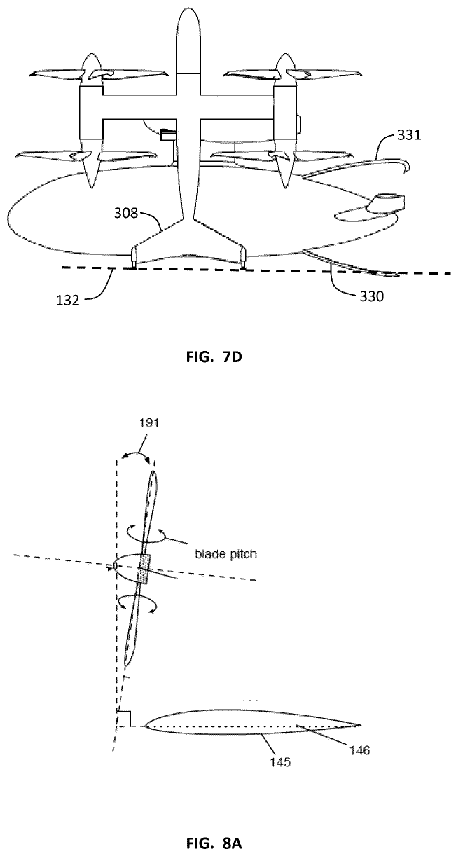

FIGS. 7A-7D illustrate the third embodiment 300 in a hover configuration, with the wings 301, 302 having pivoted from a horizontal forward facing forward flight configuration to a vertical facing vertical take-off and landing hover configuration. A left side pivot 301a facilitates the pivoting of the left wing relative to the airflow nacelle 303 and the fuselage 305, and a right side pivot 301b facilitates the pivoting of the right wing relative to the airflow nacelle 303 and the fuselage 305. FIG. 7D illustrates the aircraft 300 on the ground 132, with the landing struts 308, 309 on the ground and the upper hatch 331 open, and the lower hatch 330 open and residing on the ground. In some aspects, as when there are no storage nacelles along the wings, there may be landing struts coupled up to the airflow nacelle 203 which extend along the sides of the fuselage 205 configured to support the aerial vehicle while on the ground. In some aspects, the main fuselage 205 may have landing struts configured to support the aerial vehicle while on the ground.

Embodiments of the system and/or method can include every combination and permutation of the various system components and the various method processes, wherein one or more instances of the method and/or processes described herein can be performed asynchronously (e.g., sequentially), concurrently (e.g., in parallel), or in any other suitable order by and/or using one or more instances of the systems, elements, and/or entities described herein.

As a person skilled in the art will recognize from the previous detailed description and from the figures and claims, modifications and changes can be made to the preferred embodiments of the invention without departing from the scope of this invention defined in the following claims.

What is claimed is:

1. A vertical take-off and landing aircraft, said aircraft comprising:
a main body fuselage;
an upper airflow nacelle coupled to a top of said main body fuselage;
a left wing rotatably coupled to said upper airflow nacelle;
a right wing rotatably coupled to said upper airflow nacelle;
a plurality of left side propulsion assemblies coupled to said left wing, wherein said plurality of left side propulsion assemblies comprise:
a left side outboard propulsion assembly;
a left side inner upper propulsion assembly;
a left side inner lower propulsion assembly, wherein said left side inner upper propulsion assembly is coupled to a top end of a left side vertical pylon coupled to said left wing, and wherein said left side inner lower propulsion assembly is coupled to a bottom end of said left side vertical pylon, and wherein said left side vertical pylon is coupled to said left wing;
a plurality of propulsion assemblies coupled to said right wing, wherein said plurality of right side propulsion assemblies comprise:
a right side outboard propulsion assembly;
a right side inner upper propulsion assembly;
a right side inner lower propulsion assembly, wherein said right side inner upper propulsion assembly is coupled to a top end of a right side vertical pylon coupled to said right wing, and wherein said right side inner lower propulsion assembly is coupled to a bottom end of said right side vertical pylon, and wherein said right side vertical pylon is coupled to said right wing; and
an electric power source, said electric power source residing in said upper airflow nacelle.

2. The vertical take-off and landing aircraft of claim 1 wherein said electric power source is a turbogenerator.

3. The vertical take-off and landing aircraft of claim 1 further comprising:
a left wing nacelle, said left wing nacelle coupled to said left wing, said left wing nacelle comprising a landing strut at a rearward end; and
a right wing nacelle, said right wing nacelle coupled to said right wing, said right wing nacelle comprising a landing strut at a rearward end.

4. The vertical take-off and landing aircraft of claim 1 wherein said main body fuselage comprises:
a rear hatch, said rear hatch comprising:
an upper hatch; and
a lower hatch, said upper hatch and said lower hatch configured to raise and lower, respectively, to create an opening into an interior of said main body fuselage.

5. The vertical take-off and landing aircraft of claim 2 wherein said main body fuselage comprises:
a rear hatch, said rear hatch comprising:
an upper hatch; and
a lower hatch, said upper hatch and said lower hatch configured to raise and lower, respectively, to create an opening into an interior of said main body fuselage.

6. The vertical take-off and landing aircraft of claim 1 wherein said aircraft defines a pitch axis, and wherein said left side inner upper propulsion assembly and said left side inner lower propulsion assembly each have a spin axis, wherein the spin axes of said left side inner upper propulsion assembly and said left side inner lower propulsion assembly are parallel, and wherein the spin axes of said left side inner upper propulsion assembly and said left side inner lower propulsion assembly are offset from a spin axis of said left side outboard propulsion assembly relative to said pitch axis of said aircraft.

7. The vertical take-off and landing aircraft of claim 6 wherein said aircraft defines a pitch axis, and wherein said right side inner upper propulsion assembly and said right side inner lower propulsion assembly each have a spin axis, wherein the spin axes of said right side inner upper propulsion assembly and said right side inner lower propulsion assembly are parallel, and
wherein the spin axes of said right side inner upper propulsion assembly and said right side inner lower propulsion assembly are offset from a spin axis of said right side outboard propulsion assembly relative to said pitch axis of said aircraft.

8. The vertical take-off and landing aircraft of claim 7 wherein the spin axes of said left side inner upper propulsion assembly and said left side inner lower propulsion assembly are offset from the wing, as defined by the chord of a cross-section of the left wing, in the range of −3 to +3 degrees, and wherein the spin axis of the left side outboard propulsion assembly is offset from the wing in the range of 6-12 degrees, and wherein the spin axes of said right side inner upper propulsion assembly and said right side inner lower propulsion assembly are offset from the wing, as defined by the chord of a cross-section of the right wing, in the range of −3 to +3 degrees, and wherein the spin axis of the right side outboard propulsion assembly is offset from the wing in the range of 6-12 degrees.

9. The vertical take-off and landing aircraft of claim 7 wherein the spin axes of said left side inner upper propulsion assembly and said left side inner lower propulsion assembly are offset from the wing, as defined by the chord of a cross-section of the left wing, in the range of −5 to +15 degrees, and wherein the spin axis of the left side outboard propulsion assembly is offset from the wing in the range of 6-12 degrees, and wherein the spin axes of said right side inner upper propulsion assembly and said right side inner lower propulsion assembly are offset from the wing, as defined by the chord of a cross-section of the right wing, in the range of −5 to +15 degrees, and wherein the spin axis of the right side outboard propulsion assembly is offset from the wing in the range of 6-12 degrees.

10. The vertical take-off and landing aircraft of claim 7 wherein the spin axes of said left side inner upper propulsion assembly and said left side inner lower propulsion assembly are offset from the wing, as defined by the chord of a cross-section of the left wing, in the range of −15 to +30 degrees, and wherein the spin axis of the left side outboard propulsion assembly is offset from the wing in the range of 6-12 degrees, and wherein the spin axes of said right side inner upper propulsion assembly and said right side inner lower propulsion assembly are offset from the wing, as defined by the chord of a cross-section of the right wing, in the range of −15 to +30 degrees, and wherein the spin axis of the right side outboard propulsion assembly is offset from the wing in the range of 6-12 degrees.

11. The vertical take-off and landing aircraft of claim 1 wherein said upper airflow nacelle is detachably coupled to said main body fuselage.

12. The vertical take-off and landing aircraft of claim 11 wherein said electric power source is a turbogenerator.

13. The vertical take-off and landing aircraft of claim 11 further comprising:
a left wing nacelle, said left wing nacelle coupled to said left wing, said left wing nacelle comprising a landing strut at a rearward end; and
a right wing nacelle, said right wing nacelle coupled to said right wing, said right wing nacelle comprising a landing strut at a rearward end.

14. The vertical take-off and landing aircraft of claim 11 wherein said main body fuselage comprises:
a rear hatch, said rear hatch comprising:
an upper hatch; and
a lower hatch, said upper hatch and said lower hatch configured to raise and lower, respectively, to create an opening into an interior of said main body fuselage.

15. The vertical take-off and landing aircraft of claim 12 wherein said main body fuselage comprises:
a rear hatch, said rear hatch comprising:
an upper hatch; and
a lower hatch, said upper hatch and said lower hatch configured to raise and lower, respectively, to create an opening into an interior of said main body fuselage.

16. The vertical take-off and landing aircraft of claim 11 wherein said aircraft defines a pitch axis, and wherein said left side inner upper propulsion assembly and said left side inner lower propulsion assembly each have a spin axis, wherein the spin axes of said left side inner upper propulsion assembly and said left side inner lower propulsion assembly are parallel, and wherein the spin axes of said left side inner upper propulsion assembly and said left side inner lower propulsion assembly are offset from a spin axis of said left side outboard propulsion assembly relative to said pitch axis of said aircraft.

17. The vertical take-off and landing aircraft of claim 16 wherein said aircraft defines a pitch axis, and wherein said right side inner upper propulsion assembly and said right side inner lower propulsion assembly each have a spin axis, wherein the spin axes of said right side inner upper propulsion assembly and said right side inner lower propulsion assembly are parallel, and wherein the spin axes of said right side inner upper propulsion assembly and said right side inner lower propulsion assembly are offset from a spin axis of said right side outboard propulsion assembly relative to said pitch axis of said aircraft.

18. The vertical take-off and landing aircraft of claim 17 wherein the spin axes of said left side inner upper propulsion assembly and said left side inner lower propulsion assembly are offset from the wing, as defined by the chord of a cross-section of the left wing, in the range of −3 to +3 degrees, and wherein the spin axis of the left side outboard propulsion assembly is offset from the wing in the range of 6-12 degrees, and wherein the spin axes of said right side inner upper propulsion assembly and said right side inner lower propulsion assembly are offset from the wing, as defined by the chord of a cross-section of the right wing, in the range of −3 to +3 degrees, and wherein the spin axis of the right side outboard propulsion assembly is offset from the wing in the range of 6-12 degrees.

19. The vertical take-off and landing aircraft of claim 17 wherein the spin axes of said left side inner upper propulsion assembly and said left side inner lower propulsion assembly are offset from the wing, as defined by the chord of a cross-section of the left wing, in the range of −5 to +15 degrees, and wherein the spin axis of the left side outboard propulsion assembly is offset from the wing in the range of 6-12 degrees, and wherein the spin axes of said right side inner upper propulsion assembly and said right side inner lower propulsion assembly are offset from the wing, as defined by the chord of a cross-section of the right wing, in the range of −5 to +15 degrees, and wherein the spin axis of the right side outboard propulsion assembly is offset from the wing in the range of 6-12 degrees.

20. The vertical take-off and landing aircraft of claim 17 wherein the spin axes of said left side inner upper propulsion assembly and said left side inner lower propulsion assembly are offset from the wing, as defined by the chord of a cross-section of the left wing, in the range of −15 to +30 degrees, and wherein the spin axis of the left side outboard propulsion assembly is offset from the wing in the range of 6-12 degrees, and wherein the spin axes of said right side inner upper propulsion assembly and said right side inner lower propulsion assembly are offset from the wing, as defined by the chord of a cross-section of the right wing, in the range of −15 to +30 degrees, and wherein the spin axis of the right side outboard propulsion assembly is offset from the wing in the range of 6-12 degrees.
